(19) United States
(12) Patent Application Publication
(10) Pub. No.: US 2026/0054508 A1
(43) Pub. Date: Feb. 26, 2026

(54) PAPER DISCHARGE APPARATUS AND PAPER DISCHARGE UNIT

(71) Applicant: TOSHIBA TEC KABUSHIKI KAISHA, Tokyo (JP)

(72) Inventor: Kenji Eoka, Sunto Shizuoka (JP)

(21) Appl. No.: 19/169,030

(22) Filed: Apr. 3, 2025

(30) Foreign Application Priority Data
Aug. 22, 2024 (JP) 2024-140749

(51) Int. Cl. B41J 15/00; B41J 15/04

(52) U.S. Cl. CPC B41J 15/005; B41J 15/042

(57) ABSTRACT

According to one embodiment, a paper discharge apparatus includes a conveyance unit configured to convey paper printed by a printer and discharge the printed paper to an outside, a conveyance stop unit configured to stop the conveyance of the paper by the conveyance unit during printing of the paper, a loop mechanism configured to selectively loop the paper printed while conveyance is stopped from a conveyance path provided upstream of the conveyance unit in a conveyance direction of the paper toward any one of a printing surface side of the paper and a non-printing surface side of the paper, and a paper discharge unit configured to drive the stopped conveyance unit and discharge the looped paper when printing of the paper is completed.

### CROSS-REFERENCE TO RELATED APPLICATION

This application is based upon and claims the benefit of priority from Japanese Patent Application No. 2024-140749, filed on August 22, 2024, the entire contents of which are incorporated herein by reference.

### FIELD

Embodiments described herein relate generally to a paper discharge apparatus and a paper discharge unit.

### BACKGROUND

For example, a point of sales (POS) terminal that executes a settlement process for a commodity purchased at a store, an automated teller machine (ATM) that executes financial transactions such as cash withdrawals and deposits at a bank, and the like dispense a receipt on which settlement information and processing information are printed after processing thereof is completed. Meanwhile, to prevent a user from touching a receipt during dispensation, the above-described apparatuses may be attached with a paper discharge apparatus (built into the POS terminal, the ATM, and the like) that dispenses a receipt after printing is completed. Such a paper discharge apparatus is designed to hold a receipt therein (designed not to dispense a receipt) during printing by a printer. Specifically, the apparatus is a loop mechanism configured to hold a receipt by looping a printed paper in a direction approximately perpendicular to a conveyance direction of the receipt during printing by a printer.

However, in a paper discharge apparatus of the related art, a loop direction of a receipt is fixed to one of a printing surface side or a non-printing surface side of the receipt. Accordingly, for example, when the loop direction of the receipt is the printing surface side (for example, the upper side of the conveyance direction of the receipt) and a display is installed in the same direction, or when the loop direction of receipt is the non-printing surface side (for example, the lower side of the conveyance direction of the receipt) and a card reader or a coin dispenser is installed in the same direction, a space for looping the receipt is limited, whereby it is difficult to use the loop mechanism in the cases.

### DESCRIPTION OF THE DRAWINGS

FIG. 1 is an explanatory diagram illustrating a paper discharge unit incorporated in an information processing apparatus;

FIG. 2 is a perspective view of a paper discharge apparatus and a printer;

FIG. 3 is an explanatory diagram illustrating an internal configuration of the paper discharge apparatus and the printer;

FIG. 4 is an explanatory diagram illustrating the internal configuration of the paper discharge apparatus;

FIG. 5 is a diagram illustrating a state in which a lower flapper protrudes upward from a home position;

FIG. 6 is a diagram illustrating a state in which a receipt is conveyed in the state illustrated in FIG. 5;

FIG. 7 is a diagram illustrating a state in which the receipt is looped upward in FIG. 6;

FIG. 8 is a diagram illustrating a state in which an upper flapper protrudes downward from a home position;

FIG. 9 is a diagram illustrating a state in which the receipt is conveyed in the state illustrated in FIG. 8;

FIG. 10 is a diagram illustrating a state in which the receipt is looped downward in FIG. 9;

FIG. 11 is a block diagram illustrating a hardware configuration of the printer;

FIG. 12 is a block diagram illustrating a hardware configuration of the paper discharge apparatus;

FIG. 13 is a sequence diagram illustrating main data exchange and process between the printer and the paper discharge apparatus in time series;

FIG. 14 is a functional block diagram illustrating a functional configuration of the printer and the paper discharge apparatus;

FIG. 15 is a flowchart illustrating a flow of control of the printer; and

FIG. 16 is a flowchart illustrating a flow of control of the paper discharge apparatus.

### DETAILED DESCRIPTION

An aspect of the present disclosure is to provide a paper discharge apparatus and a paper discharge unit capable of selecting a loop direction of paper.

In general, according to one embodiment, a paper discharge apparatus includes a conveyance unit configured to convey paper printed by a printer and discharge the printed paper to an outside, a conveyance stop unit configured to stop the conveyance of the paper by the conveyance unit during printing of the paper, a loop mechanism configured to selectively loop the paper printed while the conveyance is stopped from a conveyance path provided upstream of the conveyance unit in a conveyance direction of the paper toward any one of a printing surface side of the paper and a non-printing surface side of the paper, and a paper discharge unit configured to drive the stopped conveyance unit and discharge the looped paper when printing of the paper is completed.

Hereinafter, an embodiment will be described with reference to the accompanying drawings. In the embodiment, for example, a paper discharge unit incorporated in an information processing apparatus such as a POS terminal, an ATM, or a kiosk terminal will be described. In the embodiment, the POS terminal will be described as an example of the information processing apparatus, and a receipt will be described as an example of paper.

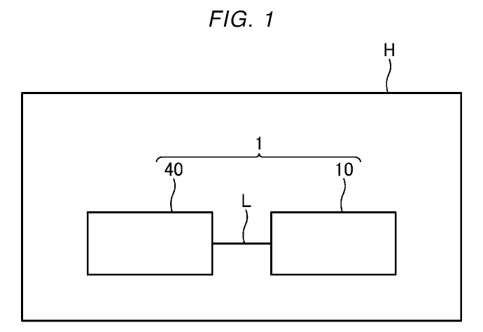

FIG. 1 is a diagram illustrating an information processing apparatus H and a paper discharge unit 1 incorporated in the information processing apparatus H. In FIG. 1, if the information processing apparatus H is a POS terminal, the information processing apparatus H executes a commodity registration process and a settlement process for commodities sold in a store. The paper discharge unit 1 prints and dispenses a receipt on which commodity information (a commodity name, a commodity price) and settlement information (a total amount, a deposit amount, a change, and the like) of a commodity for which the commodity registration process and the settlement process are completed are written.

The paper discharge unit 1 includes a printer 10 and a paper discharge apparatus 40. The printer 10 is a device (for example, a thermal printer) that prints commodity information and settlement information of a commodity for which the settlement process is completed on paper (for example, thermal paper). The paper discharge apparatus 40 is a device that dispenses a receipt printed by the printer 10. Specifically, the printer 10 pulls out paper wound in a roll shape to print commodity information and settlement information of a commodity for which the settlement process is completed on the paper and feeds the printed receipt to the paper discharge apparatus 40. When printing is completed, the printer 10 cuts the receipt using a cutter. The paper discharge apparatus 40 is connected to the printer 10 via a communication line L, and stores the receipt fed from the printer 10 inside the apparatus. Upon receiving a signal indicating that the receipt is cut from the printer 10 via the communication line L, the paper discharge apparatus 40 discharges the receipt stored inside the apparatus to the outside.

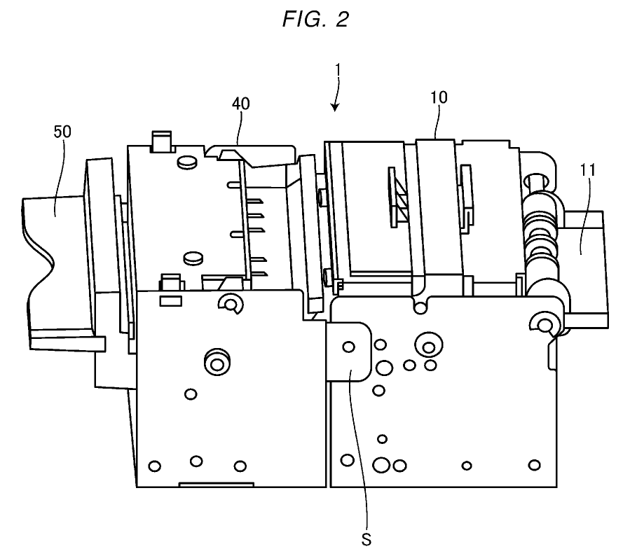

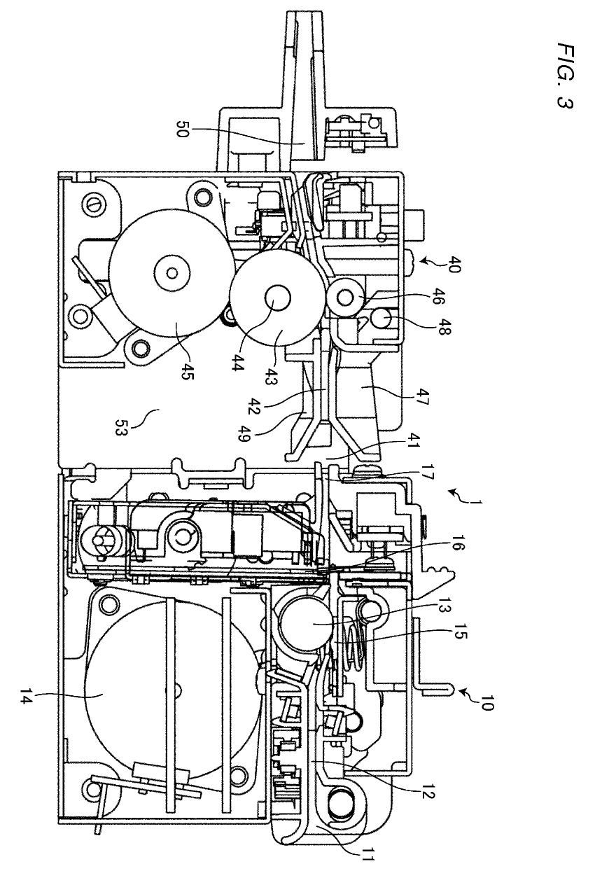

FIG. 2 is a perspective view of the printer 10 and the paper discharge apparatus 40 configuring the paper discharge unit 1. FIG. 3 is an explanatory diagram illustrating an internal configuration of the printer 10 and the paper discharge apparatus 40. As illustrated in FIGS. 2 and 3, the printer 10 and the paper discharge apparatus 40 are fixedly connected to each other by a connection portion S (for example, screw fastening).

The printer 10 includes a paper introduction port 11, a conveyance path 12, a platen 13, a platen motor 14, a printing head 15, a cutter 16, and a receipt feeding port 17. The paper introduction port 11 is an opening through which paper pulled out from an outermost portion of roll paper (not illustrated) is introduced into the printer 10, in which the roll paper is long-sized paper (for example, thermal paper) wound in a roll shape. The conveyance path 12 is a conveyance path that guides the introduced paper to the printing head 15. The platen 13 is, for example, a rubber-like member formed in a cylindrical shape and is rotated by driving the platen motor 14 (refer to FIG. 3), thereby conveying the paper introduced through the paper introduction port 11.

The printing head 15 is, for example, a thermal head in which heating elements are arranged in a line shape. The printing head 15 is provided at a position facing the platen 13 and is pressed against the platen 13 by a pressure contact mechanism (not illustrated). In FIG. 3, the printing head 15 is mounted on the upper portion of the platen 13 and is pressed against with the platen 13 from above. The printing head 15 and the platen 13 sandwich the paper at a contact portion. The printing head 15 prints on the sandwiched paper. That is, the printing head 15 prints on the paper conveyed by rotation of the platen 13. In the example of FIG. 3, the printing head 15 performs printing on the conveyed paper from above. That is, a surface of the paper in contact with the printing head 15 is a printing surface, and a surface of the paper in contact with the platen 13 is a non-printing surface. The platen 13 conveys the paper printed by the printing head 15 as a receipt from the receipt feeding port 17 to the paper discharge apparatus 40 (that is, the platen 13 is rotated to feed the receipt from the receipt feeding port 17 to the paper discharge apparatus 40).

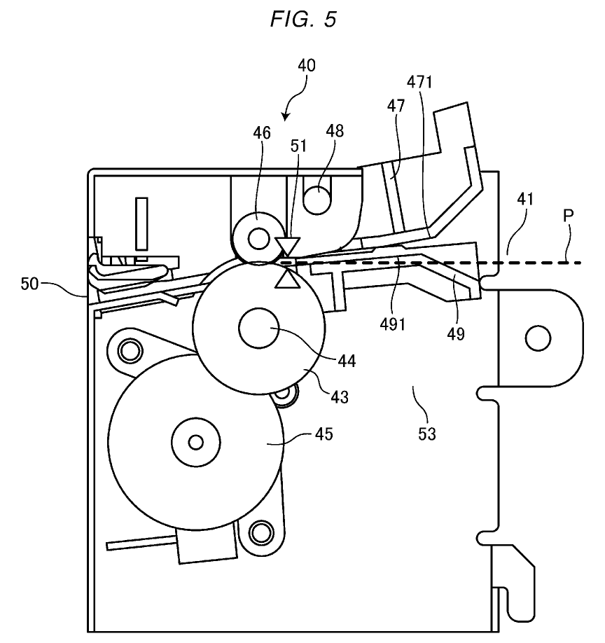

The cutter 16 is provided at a downstream position close to the platen 13 and the printing head 15. The cutter 16 cuts the receipt by driving a cutter solenoid 31 (refer to FIG. 5). The cutter 16 cuts a rear end of the receipt printed by the printing head 15 and conveyed by the platen 13. When the receipt is cut by the cutter 16, the receipt is fed to the inside of the paper discharge apparatus 40.

In the printer 10, the platen 13 is rotated to convey the paper introduced through the paper introduction port 11 from the conveyance path 12 to the printing head 15, the printing head 15 prints on the paper. The printed receipt is then fed from the receipt feeding port 17 to the paper discharge apparatus 40. When printing by the printing head 15 is completed, the printer 10 uses the cutter 16 to cut the rear end of the receipt. Then, the printer 10 transmits a cutting signal (an end signal) indicating that the receipt is cut to the paper discharge apparatus 40.

The paper discharge apparatus 40 includes a paper introduction port 41, a conveyance path 42, a feed roller 43 (a conveyance unit), a feed motor 45, a pinch roller 46, and a receipt discharge port 50. The paper introduction port 41 is provided at a position close to the receipt feeding port 17 and is an opening through which a receipt fed from the receipt feeding port 17 is introduced to the inside of the paper discharge apparatus 40. The conveyance path 42 is a conveyance path that guides the receipt introduced through the paper introduction port 41 to the feed roller 43. The feed roller 43 is, for example, a rubber-like member formed in a cylindrical shape and is rotated around a support shaft 44 to convey the receipt introduced through the paper introduction port 41. The feed motor 45 is a motor (for example, a stepping motor) that rotates the feed roller 43. The pinch roller 46 is a driven roller pressed against the feed roller 43 and is rotated in conjunction with rotation of the feed roller 43. The receipt is sandwiched between the feed roller 43 and the pinch roller 46. The receipt conveyed by rotation of the feed roller 43 is discharged from the receipt discharge port 50 to the outside of the POS terminal H (through a receipt dispensing port). The discharged receipt is taken by a customer.

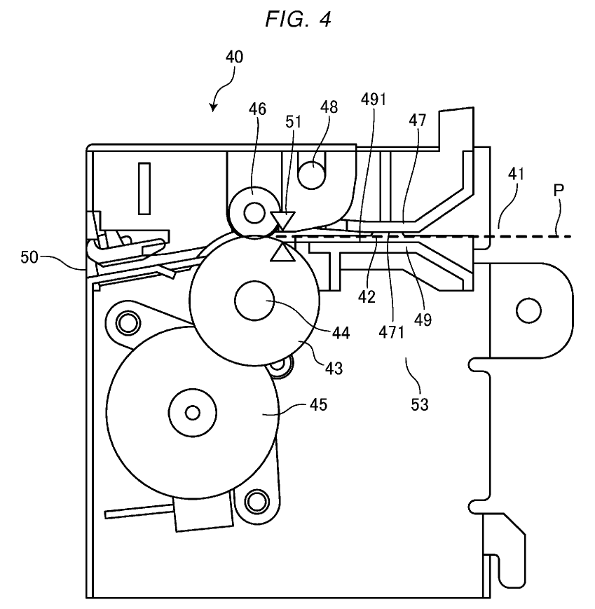

The paper discharge apparatus 40 also includes a paper sensor 51. As illustrated in FIG. 4, the paper sensor 51 is provided directly adjacent to the feed roller 43 and the pinch roller 46 on the upstream side in the conveyance direction of the receipt. The paper sensor 51 is a sensor that detects the receipt fed from the printer 10, introduced through the paper introduction port 41, and conveyed along the conveyance path 42. The paper sensor 51 is, for example, an optical sensor. The paper sensor 51 detects the receipt conveyed to the feed roller 43 and the pinch roller 46 and immediately before being sandwiched between the feed roller 43 and the pinch roller 46.

The paper discharge apparatus 40 also includes an upper flapper 47 and a lower flapper 49. The upper flapper 47 and the lower flapper 49 are provided between the paper introduction port 41 and the feed roller 43. The configuration of each of the upper flapper 47 and the lower flapper 49 will be described with reference to FIG. 4. In FIG. 4, the lower flapper 49 can be rotated around the support shaft 44. The lower flapper 49 is rotated in conjunction with rotation of a flapper motor 57 (not illustrated) that is, for example, a stepping motor. The paper discharge apparatus 40 also includes a home position sensor 58 (not illustrated) that detects a state in which the flapper motor 57 is located at a home position P. The home position sensor 58 is, for example, an optical sensor. When the home position sensor 58 detects the lower flapper 49, rotation of the flapper motor 57 is stopped, thereby positioning the lower flapper 49 at the home position P. That is, when the lower flapper 49 is detected by the home position sensor 58, the lower flapper 49 is located at the home position P.

The upper flapper 47 is configured to be rotatable around a support shaft 48. The upper flapper 47 is rotated around the support shaft 48 due to the weight thereof and abuts on the lower flapper 49 from above. When the lower flapper 49 is located at the home position P, the upper flapper 47 abutting on the lower flapper 49 is located at the home position P. The lower flapper 49 and the upper flapper 47 are located at the home position P to form the conveyance path 42. Specifically, the lower flapper 49 includes a conveyance surface 491, and the upper flapper 47 includes a conveyance surface 471. When the upper flapper 47 abuts on the lower flapper 49 located at the home position P (when the upper flapper 47 is also located at the home position P), the conveyance surface 491 and the conveyance surface 471 face each other with a predetermined gap therebetween. When the lower flapper 49 and the upper flapper 47 are both located at the home position P, a space formed between the conveyance surface 491 and the conveyance surface 471 serves as the conveyance path 42.

As described above, the paper discharge unit including the printer 10 and the paper discharge apparatus 40 is incorporated in the POS terminal. As illustrated in FIG. 3, when the lower flapper 49 and the upper flapper 47 are both located at the home position, the receipt feeding port 17, the paper introduction port 41, and the conveyance path 42 are arranged in a straight line at approximately the same height. That is, the receipt fed from the receipt feeding port 17 is conveyed in a substantially straight line along the paper introduction port 41 and the conveyance path 42.

Here, the upper flapper 47 abutting on the lower flapper 49 is moved in conjunction with movement of the lower flapper 49. For example, when the lower flapper 49 is rotated upward from the home position P, the upper flapper 47 is rotated in conjunction with movement of the lower flapper 49, and more specifically, the upper flapper 47 is rotated upward by a distance of rotation of the lower flapper 49. When the lower flapper 49 is rotated upward, at least a part of the conveyance surface 491 (that is, at least a part of the lower flapper 49) protrudes upward from the home position P.

FIG. 5 is a diagram illustrating a state in which at least a part of the lower flapper 49 protrudes upward from the home position P. In FIG. 5, at least a part of the lower flapper 49 (specifically, a part of the conveyance surface 491) protrudes upward from the home position P. When the lower flapper 49 is rotated upward, the upper flapper 47 is lifted upward by the amount of movement of the lower flapper 49.

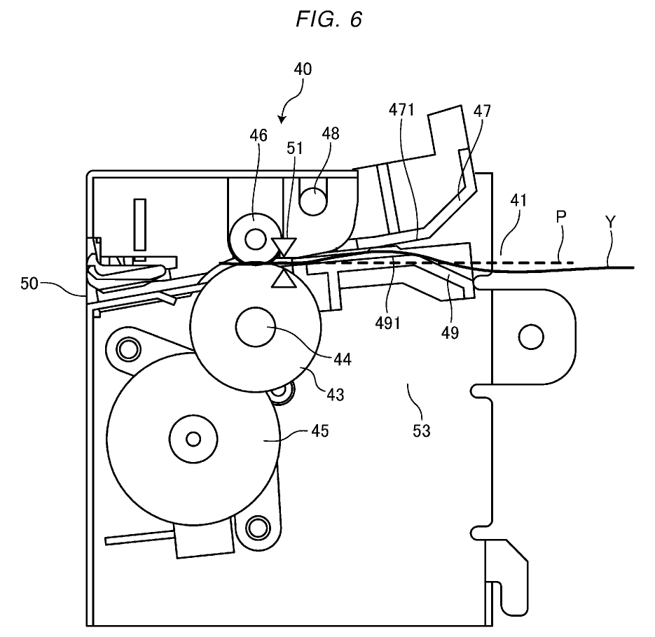

FIG. 6 is a diagram illustrating a state in which a receipt is fed from the printer 10 and at least a part of the lower flapper 49 protrudes upward from the home position P. As illustrated in FIG. 6, a receipt Y fed from the printer 10 is sandwiched between the feed roller 43 and the pinch roller 46, and the conveyance surface 491 of the lower flapper 49 protrudes upward. When the receipt Y fed from the printer 10 is detected by the paper sensor 51 while the lower flapper 49 is at the home position, the feed roller 43 is rotated by a predetermined amount (that is, the receipt Y is conveyed by a predetermined distance) and the fed receipt Y is sandwiched between the feed roller 43 and the pinch roller 46. The rotation of the feed roller 43 stops when the feed roller 43 is rotated by a predetermined amount. Then, the conveyance surface 491 of the lower flapper 49 protrudes upward. FIG. 6 illustrates such a state.

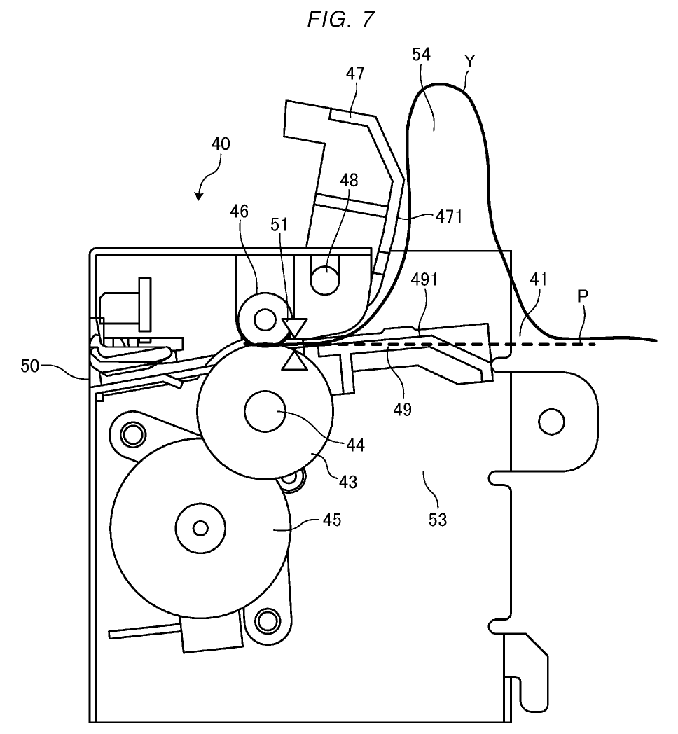

FIG. 7 is a diagram illustrating a state in which the receipt Y is further fed in the state illustrated in FIG. 6. As illustrated in FIG. 7, a front end of the receipt Y is sandwiched between the stopped (not rotating) feed roller 43 and the pinch roller 46, and the receipt Y protrudes upward by the lower flapper 49 protruding upward from the home position P. Accordingly, when the receipt Y is further fed, the receipt Y is bent upward and is looped upward. The receipt Y is looped upward and lifts the upper flapper 47 upward. The upper flapper 47 lifted upward is rotated around the support shaft 48 serving as a fulcrum to open the top surface of the paper discharge apparatus 40 (resulting in the state illustrated in FIG. 7). The receipt Y looped upward is exposed to an external space 54 from the top surface of the paper discharge apparatus 40 and is retreated toward the external space 54 (the receipt Y is held in the external space 54). Here, since the paper discharge unit 1 is built into the POS terminal H, the customer cannot touch the receipt Y retreated toward the external space.

When the lower flapper 49 is rotated downward from the home position P, the upper flapper 47 is rotated downward in conjunction with movement of the lower flapper 49 at first. However, after the upper flapper 47 abuts on a stopper (not illustrated) (the stopper is formed, for example, on a frame of the paper discharge apparatus 40), the upper flapper 47 does not follow the downward rotation of the lower flapper 49 and remains at the position where the upper flapper 47 abuts on the stopper. As the upper flapper 47 is rotated downward to the position of the stopper, at least a part of the conveyance surface 471 (that is, at least a part of the upper flapper 47) protrudes downward from the home position P.

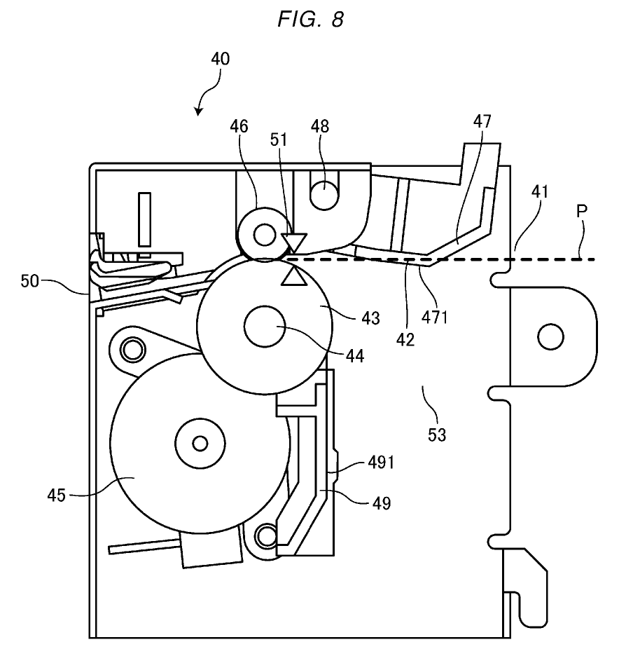

FIG. 8 is a diagram illustrating a state in which at least a part of the upper flapper 47 protrudes downward from the home position P. In FIG. 8, the lower flapper 49 is located at a retreat position at which the lower flapper 49 is rotated approximately 90° downward from the home position P. Since the upper flapper 47 abuts on the stopper, rotation of the upper flapper 47 is stopped at a position where at least a part of the upper flapper 47 (specifically, a part of the conveyance surface 471) protrudes downward from the home position P. As the lower flapper 49 is rotated to the retreat position, a space 53 is formed inside the paper discharge apparatus 40.

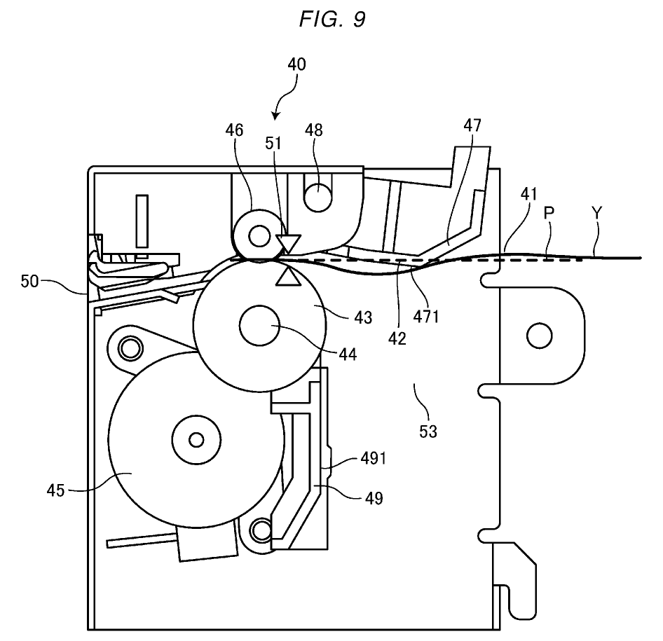

FIG. 9 is a diagram illustrating a state in which a receipt is fed from the printer 10 and at least a part of the upper flapper 47 protrudes downward from the home position P. When the lower flapper 49 and the upper flapper 47 are at the home position, the receipt Y fed from the printer 10 is conveyed to the inside of the paper discharge apparatus 40. When the receipt Y is detected by the paper sensor 51, the feed roller 43 is rotated by a predetermined amount (that is, the receipt Y is conveyed by a predetermined distance), and the fed receipt Y is sandwiched between the feed roller 43 and the pinch roller 46. The rotation of the feed roller 43 stops when the feed roller 43 is further rotated by a predetermined amount. Then, the lower flapper 49 is rotated to the retreat position, and the upper flapper 47 is moved downward, whereby the conveyance surface 471 of the upper flapper 47 protrudes downward. FIG. 9 illustrates such a state.

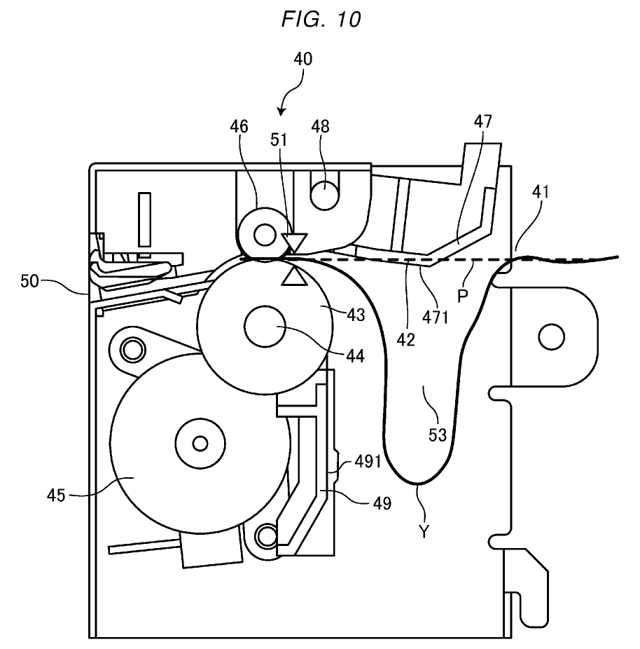

FIG. 10 is a diagram illustrating a state in which the receipt Y is further fed in the state illustrated in FIG. 9. As illustrated in FIG. 10, the front end of the receipt Y is sandwiched between the stopped (not rotating) feed roller 43 and the pinch roller 46, and the receipt Y protrudes downward due to the upper flapper 47 protruding downward from the home position P. Accordingly, when the receipt Y is further fed, the receipt Y is bent downward and is looped downward. In other words, the receipt Y is looped downward and is retreated toward the space 53 (the receipt Y is held in the space 53). Since the paper discharge unit 1 is built into the POS terminal H, the customer cannot touch the receipt Y retreated toward the space 53.

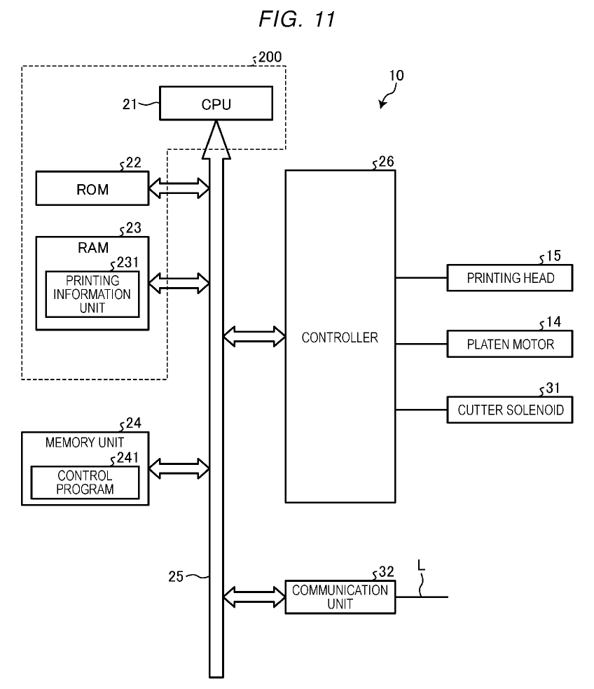

Hereinafter, a hardware configuration of the printer 10 will be described. FIG. 11 is a block diagram illustrating the hardware configuration of the printer 10. As illustrated in FIG. 11, the printer 10 includes a central processing unit (CPU) 21 as an example of a processor, a read only memory (ROM) 22, a random access memory (RAM) 23, a memory unit 24, and the like. The CPU 21 is a main controller. The ROM 22 stores various programs. The RAM 23 allows programs and various types of data to be loaded therein. The memory unit 24 stores various programs. The CPU 21, the ROM 22, the RAM 23, and the memory unit 24 are connected to each other via a bus 25. The CPU 21, the ROM 22, and the RAM 23 configure a control unit 200. In other words, the control unit 200 executes a control process of the printer 10 to be described later by operating the CPU 21 according to the control program stored in the ROM 22 or the memory unit 24 and loaded in the RAM 23.

The RAM 23 includes a printing information unit 231. The printing information unit 231 stores printing information received from the information processing apparatus.

The memory unit 24 is configured of a non-volatile memory such as a hard disc drive (HDD) or a flash memory in which storage information is stored even if power is turned off. The memory unit 24 includes a control program unit 241. The control program unit 241 stores the control program for controlling the printer 10.

The control unit 200 is connected to the printing head 15, the platen motor 14, and the cutter solenoid 31 via the bus 25 and a controller 26. The printing head 15 applies heat to print characters and figures on the printing surface side of the paper sandwiched between the platen 13 and the printing head 15. The printing head 15 prints based on the printing information stored in the printing information unit 231. The platen motor 14 rotates the platen 13 by being driven. The cutter solenoid 31 operates the cutter 16 by being driven. When the cutter 16 is operated, the receipt Y is cut.

The controller 26 receives an instruction from the control unit 200 and controls the printing head 15, the platen motor 14, and the cutter solenoid 31. Hereinafter, for convenience of explanation, control performed by the controller 26 will be described as being performed by the control unit 200.

The control unit 200 is connected to a communication unit 32 (an I/O interface) via the bus 25. The communication unit 32 is communicatively connected to the paper discharge apparatus 40 via the communication line L such as a local area network (LAN).

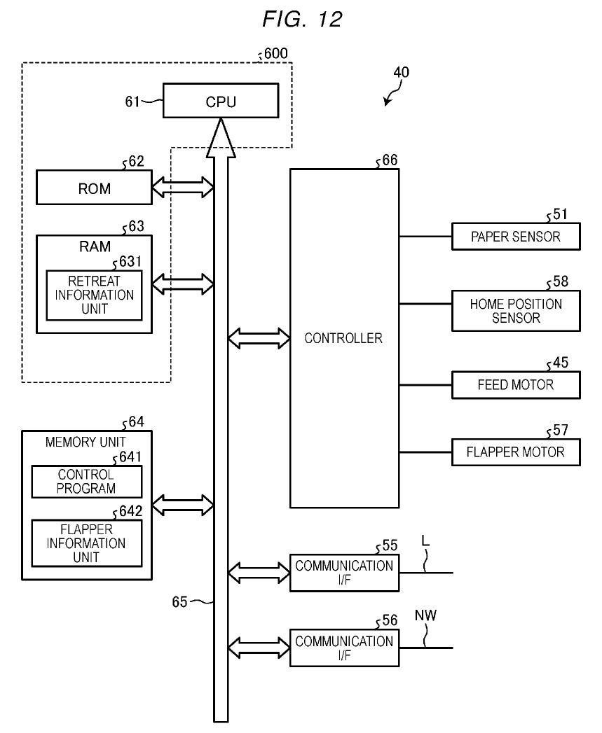

Next, a hardware configuration of the paper discharge apparatus 40 will be described. FIG. 12 is a block diagram illustrating the hardware configuration of the paper discharge apparatus 40. As illustrated in FIG. 12, the paper discharge apparatus 40 includes a CPU 61 as an example of a processor, a ROM 62, a RAM 63, a memory unit 64, and the like. The CPU 61 serves as a main controller. The ROM 62 stores various programs. The RAM 63 allows programs and various types of data to be loaded therein. The memory unit 64 stores various programs. The CPU 61, the ROM 62, the RAM 63, and the memory unit 64 are connected to each other via a bus 65. The CPU 61, the ROM 62, and the RAM 63 configure the control unit 600. In other words, the control unit 600 executes a control process of the paper discharge apparatus 40 to be described later by operating the CPU 61 according to the control program stored in the ROM 62 or the memory unit 64 and loaded in the RAM 63.

The RAM 63 includes a retreat information unit 631. The retreat information unit 631 stores retreat information indicating whether the receipt Y is to be looped (retreated) to the upper side or is to be looped (retreated) to the lower side. The retreat information is received from the POS terminal H via a communication line NW to be described later. Depending on a peripheral state of the paper discharge unit 1 incorporated into the POS terminal H, for example, if there is no device such as a display above the paper discharge unit 1 and there is another device below the paper discharge unit 1, an operator uses the POS terminal H to transmit retreat information indicating that the receipt Y is to be retreated upward. If there is another device such as an indicator above the paper discharge unit 1 and there is no device below the paper discharge unit 1, an operator uses the POS terminal H to transmit retreat information indicating that the receipt Y is to be retreated downward.

The memory unit 64 is configured of a non-volatile memory such as an HDD or a flash memory in which storage information is stored even if power is turned off. The memory unit 64 includes a control program unit 641 and a flapper information unit 642. The control program unit 641 stores the control program for controlling the paper discharge apparatus 40. The flapper information unit 642 stores movement information of the lower flapper 49 from the home position P. The flapper information unit 642 stores movement information of the lower flapper 49 from the home position P for each of the retreat information stored in the retreat information unit 631. For example, as movement information for retreat information indicating that the receipt Y is to be retreated upward stored in the retreat information unit 631, the flapper information unit 642 stores information indicating an upward movement distance of the lower flapper 49 from the home position P to a protruding position illustrated in FIG. 6 (specifically, information on rotation of the lower flapper 49 located at the home position P to allow the lower flapper 49 to reach the protruding position illustrated in FIG. 6 (number of rotation steps of the flapper motor 57)). As movement information for retreat information indicating that the receipt Y is to be retreated downward stored in the retreat information unit 631, the flapper information unit 642 stores information indicating a downward movement distance of the lower flapper 49 from the home position P to the retreat position illustrated in FIG. 9 (specifically, information on rotation of the lower flapper 49 located at the home position P to allow the lower flapper 49 to reach the retreat position illustrated in FIG. 9 (number of rotation steps of the flapper motor 57)).

The control unit 600 is connected to the paper sensor 51, the home position sensor 58, the feed motor 45, and the flapper motor 57 via the bus 65 and a controller 66. The paper sensor 51 detects the receipt Y at a position immediately before the feed roller 43 and the pinch roller 46. The home position sensor 58 detects the lower flapper 49 positioned at the home position P. When the home position sensor 58 detects the lower flapper 49, the lower flapper 49 is positioned at the home position P. The feed motor 45 is a motor that rotates the feed roller 43. The flapper motor 57 is a motor that rotates the lower flapper 49.

The controller 66 receives an instruction from the control unit 600 and controls the paper sensor 51, the home position sensor 58, the feed motor 45, and the flapper motor 57. Hereinafter, for convenience of explanation, control performed by the controller 66 will be described as being performed by the control unit 600.

The control unit 600 is connected to a communication unit 55 (an I/O interface) via the bus 65. The communication unit 55 is communicatively connected to the printer 10 via the communication line L.

The control unit 600 is connected to a communication unit 56 (an I/O interface) via the bus 65. The communication unit 56 is communicatively connected to the POS terminal H via the communication line NW.

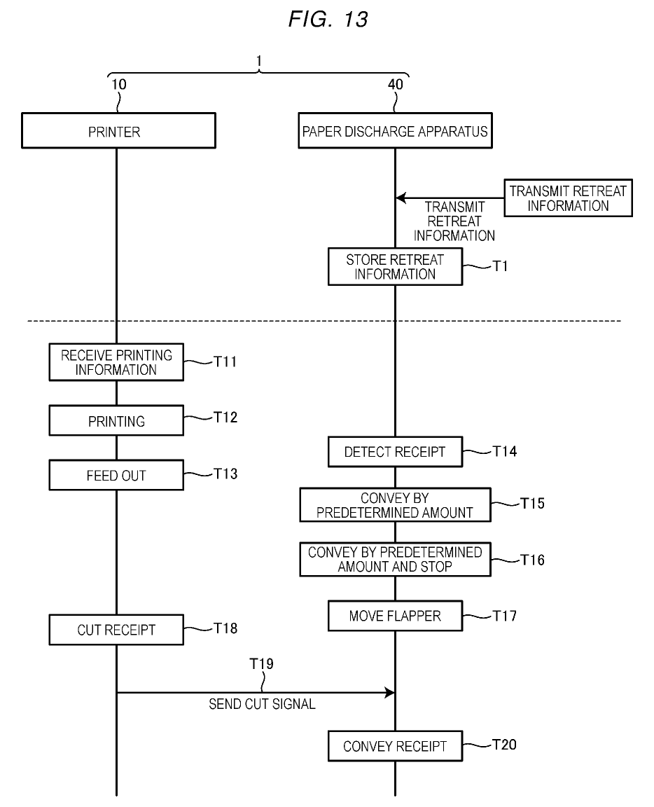

Next, a process of the printer 10 and the paper discharge apparatus 40 in the paper discharge unit 1 and exchange of signals between the devices will be described. FIG. 13 is a sequence diagram illustrating main data exchange and process between the printer 10 and the paper discharge apparatus 40 in time series. When the paper discharge unit 1 is incorporated into the POS terminal H, whether to retreat the receipt Y toward the upper side or the lower side is determined based on an arrangement state of peripheral devices of the incorporated paper discharge unit 1, and information is set in the POS terminal H. The POS terminal H transmits retreat information based on the set information to the paper discharge apparatus 40. The paper discharge apparatus 40 stores the received retreat information in the retreat information unit 631 (T1).

As such, in the POS terminal H having the paper discharge apparatus 40 for storing the retreat information incorporated thereinto, the upper flapper 47 and the lower flapper 49 are located at the home position until the paper discharge apparatus 40 detects the receipt printed by the printer 10. When the settlement process for a commodity is executed, the POS terminal H transmits commodity information and settlement information of the commodity for which the settlement process is completed to the printer 10 as printing information. The printer 10 receives the printing information (T11). The printer 10 conveys paper and uses the printing head 15 to print the printing information on the conveyed paper (T12). Thereafter, the printer 10 feeds the printed receipt Y to the paper discharge apparatus 40 (T13).

The paper discharge apparatus 40 receives the receipt Y fed from the printer 10. The paper sensor 51 of the paper discharge apparatus 40 detects the front end of the received receipt Y (T14). Then, the paper discharge apparatus 40 rotates the feed roller 43 by a predetermined amount to convey the receipt Y by a predetermined distance (T15). By conveying the receipt Y by the predetermined distance, the front end of the receipt Y is sandwiched between the feed roller 43 and the pinch roller 46. Thereafter, the paper discharge apparatus 40 stops rotation of the feed roller 43 (T16). Next, the paper discharge apparatus 40 drives the flapper motor 57 by a predetermined number of steps based on the retreat information stored in T1 to rotate the lower flapper 49 to any one of a position at which at least a part of the lower flapper 49 protrudes upward from the home position P (the position in FIG. 5) and the retreat position (the position in FIG. 8) (T17). When the lower flapper 49 is rotated to the retreat position, the upper flapper 47 is located at a position at which at least a part of the upper flapper 47 protrudes downward from the home position P (T17).

Here, the printer 10 continues to feed the printed receipt Y. Then, the paper discharge apparatus 40 causes the receipt Y to retreat upward or downward by looping a middle portion of the receipt Y upward or downward based on the positions of the lower flapper 49 and the upper flapper 47 determined in T1.

Meanwhile, the printer 10 cuts the rear end of the receipt Y when printing is completed (T18). The printer 10 then transmits a cut signal indicating that the receipt Y is cut (an example of an end signal) to the paper discharge apparatus 40 (T19). Upon receiving the cut signal, the paper discharge apparatus 40 restarts rotation of the feed roller 43 stopped in T16, and resumes conveyance of the looped and retreated receipt Y (T20). The conveyed receipt Y is discharged to the outside of the POS terminal H (the receipt Y is dispensed).

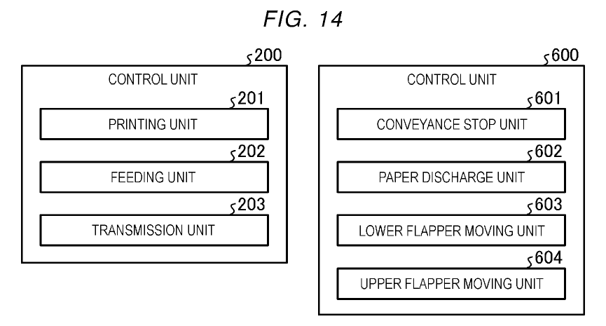

Hereinafter, a functional configuration of the printer 10 and the paper discharge apparatus 40 will be described. FIG. 14 is a functional block diagram illustrating the functional configuration of the printer 10 and the paper discharge apparatus 40. The control unit 200 of the printer 10 functions as a printing unit 201, a feeding unit 202, and a transmission unit 203 by following the control program stored in the ROM 22 or the control program unit 241 of the memory unit 24.

The printing unit 201 prints information on paper. Specifically, the printing unit 201 uses the printing head 15 to print commodity information and settlement information related to a purchased commodity on a long-sized thermal paper introduced through the paper introduction port 11.

The feeding unit 202 feeds the printed receipt Y to the paper discharge apparatus 40. Specifically, the feeding unit 202 rotates the platen 13 to feed the printed receipt Y to the paper discharge apparatus 40.

The transmission unit 203 transmits an end signal indicating that printing is completed to the paper discharge apparatus 40. Specifically, the transmission unit 203 transmits a cut signal indicating that the receipt Y is cut by the cutter 16 to the paper discharge apparatus 40. More specifically, when the cutter 16 cuts the receipt Y, the transmission unit 203 transmits the cut signal indicating that the receipt Y is cut to the paper discharge apparatus 40.

The control unit 600 of the paper discharge apparatus 40 functions as a conveyance stop unit 601, a paper discharge unit 602, a lower flapper moving unit 603, and an upper flapper moving unit 604 by following the control program stored in the ROM 62 or the control program unit 641 of the memory unit 64.

The conveyance stop unit 601 stops conveyance of the receipt Y by the feed roller 43 during printing on paper by the printer 10. Specifically, the conveyance stop unit 601 stops conveyance of the receipt Y by the feed roller 43 until the cut signal is received from the printer 10.

When printing of the receipt Y is completed, the paper discharge unit 602 drives the stopped feed roller 43 to discharge the looped receipt Y. Specifically, upon receiving the cut signal, the paper discharge unit 602 drives the stopped feed roller 43 to discharge the looped receipt Y to the outside of the POS terminal H.

The lower flapper moving unit 603 causes at least a part of the lower flapper 49 to protrude upward from the home position P. Specifically, the lower flapper moving unit 603 drives the flapper motor 57 to rotate the lower flapper 49 upward, and at least a part of the lower flapper 49 protrudes upward from the home position P.

The upper flapper moving unit 604 causes at least a part of the upper flapper 47 to protrude downward from the home position P. Specifically, the upper flapper moving unit 604 rotates the lower flapper 49 downward, thereby causing the upper flapper 47 to be rotated downward until the upper flapper 47 abuts on a stopper. Accordingly, at least a part of the upper flapper 47 protrudes downward from the home position P.

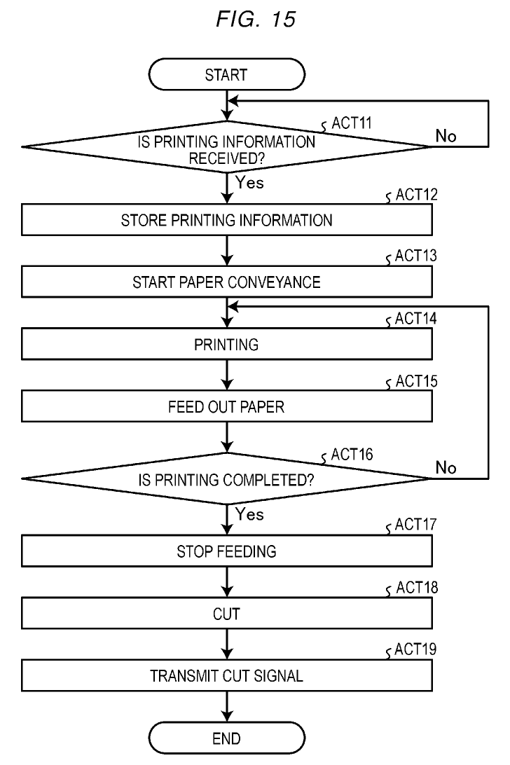

Hereinafter, control of the printer 10 will be described. FIG. 15 is a flowchart illustrating a flow of the control process of the printer 10. As illustrated in FIG. 15, the control unit 200 of the printer 10 determines whether printing information is received from the POS terminal H (ACT11). The printer 10 waits until the printing information is received (No in ACT11). Upon determining that the printing information is received (Yes in ACT11), the control unit 200 stores the received printing information in the printing information unit 231 (ACT12). Then, the control unit 200 drives the platen motor 14 to rotate the platen 13 and to start conveyance of the paper (ACT13). The printing unit 201 drives the printing head 15 to print on the paper based on the stored printing information (ACT14). Next, the feeding unit 202 rotates the platen 13 to feed the printed receipt Y from the receipt feeding port 17 to the paper discharge apparatus 40 (ACT15).

Then, the control unit 200 determines whether printing based on the printing information is completed (ACT16). Upon determining that printing is not completed (No in ACT16), the control unit 200 returns to ACT14 and continues printing. Upon determining that printing is completed (Yes in ACT16), the control unit 200 stops feeding the receipt Y by the platen 13 (ACT17). Thereafter, the control unit 200 drives the cutter 16 using the cutter solenoid 31 and cuts the rear end of the receipt Y (ACT18). Then, the transmission unit 203 transmits the cut signal (the end signal) indicating that the receipt Y is cut in ACT18 to the paper discharge apparatus 40 (ACT19). Next, the control unit 200 ends the process and returns to ACT11.

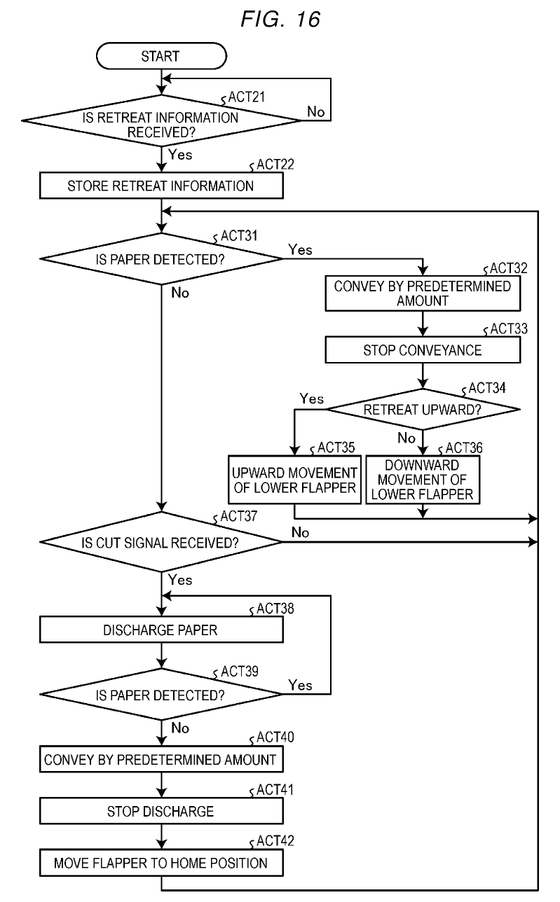

Next, control of the paper discharge apparatus 40 will be described. FIG. 16 is a flowchart illustrating a flow of the control of the paper discharge apparatus 40. When incorporating the paper discharge apparatus 40 into the POS terminal H, the paper discharge apparatus 40 receives retreat information from the POS terminal H. As illustrated in FIG. 16, the control unit 600 of the paper discharge apparatus 40 determines whether the retreat information is received from the POS terminal H (ACT21). The control unit 600 waits until the retreat information is received (No in ACT21). Upon determining that the retreat information is received (Yes in ACT21), the control unit 600 stores the received retreat information in the retreat information unit 631 (ACT22).

The upper flapper 47 and the lower flapper 49 are located at the home position. Here, the control unit 600 determines whether the paper sensor 51 detects the front end of the receipt Y fed from the printer 10 (ACT31). Upon determining that the paper sensor 51 detects the front end of the receipt Y (Yes in ACT31), the control unit 600 rotates the feed roller 43 by a predetermined amount to convey the receipt Y by a predetermined distance (ACT32). By performing the process in ACT32, the feed roller 43 and the pinch roller 46 sandwich the front end of the receipt Y. Thereafter, the conveyance stop unit 601 stops rotation of the feed roller 43 while sandwiching the front end of the receipt Y, thereby stopping conveyance of the receipt Y (ACT33).

The control unit 600 then determines whether the retreat information stored in the retreat information unit 631 is retreat information indicating that the receipt Y is to be retreated toward the upper side (the external space 54 side) (ACT34). Upon determining that the retreat information indicates that the receipt Y is to be retreated toward the upper side (Yes in ACT34), the lower flapper moving unit 603 rotates the lower flapper 49 to a position at which at least a part of the lower flapper 49 protrudes upward from the home position P (ACT35) based on information read from the flapper information unit 642 and indicating an upward movement distance of the lower flapper 49 from the home position P (information on rotation of the lower flapper 49 located at the home position P to allow the lower flapper 49 to reach the protruding position illustrated in FIG. 6 (the number of rotation steps of the flapper motor 57)). Then, the control unit 600 returns to ACT31.

Upon determining that the retreat information is not retreat information indicating that the receipt Y is to be retreated toward the upper side (that is, the retreat information indicates that the receipt Y is to be retreated toward the lower side) (No in ACT34), the upper flapper moving unit 604 rotates the lower flapper 49 to the retreat position (ACT36) based on information read from the flapper information unit 642 and indicating a downward movement distance of the lower flapper 49 from the home position P to the retreat position illustrated in FIG. 8, (the number of rotation steps of the flapper motor 57). When the lower flapper 49 is rotated to the retreat position, the upper flapper 47 located at the home position P is moved to a position at which the upper flapper 47 abuts on the stopper, and the upper flapper 47 is rotated to a position at which the upper flapper 47 protrudes downward from the home position P illustrated in FIG. 8. Then, the control unit 600 returns to ACT31.

When the upper flapper 47 and the lower flapper 49 are moved as such, the receipt Y is continuously fed from the printer 10. Here, the process in ACT23 is executed. When at least a part of the lower flapper 49 is located at a position at which the lower flapper 49 protrudes upward from the home position P, the receipt Y fed from the printer 10 is looped upward and is retreated toward the external space 54. When the process in ACT24 is executed and at least a part of the upper flapper 47 is located at a position at which the upper flapper 47 protrudes downward from the home position P, the receipt Y fed from the printer 10 is looped downward and is retreated toward the space 53. Then, the control unit 600 returns to ACT31.

Upon determining that the front end of the receipt Y is not detected (No in ACT31), the control unit 600 determines whether a cut signal is received from the printer 10 (ACT37). Upon determining that the cut signal is not received (No in ACT37), the control unit 600 returns to ACT31. Upon determining that the cut signal is received from the printer 10 (Yes in ACT37), the paper discharge unit 602 rotates the feed roller 43 stopped in ACT33 and starts to discharge the receipt Y retreated upward or downward to the outside of the POS terminal H (ACT38).

Next, the control unit 600 determines whether the paper sensor 51 detects the rear end of the receipt Y to be discharged (ACT39). Upon determining that the rear end of the receipt Y is not detected (No in ACT39), the control unit 600 returns to ACT38 and continuously discharges the receipt Y. Upon determining that the rear end of the receipt Y is detected (Yes in ACT39), the control unit 600 conveys the receipt Y by a predetermined amount until the receipt is completely discharged (ACT40). The control unit 600 stops rotation of the feed roller 43 (ACT41). Thereafter, the control unit 600 returns the upper flapper 47 and the lower flapper 49 to the home position (ACT42). Then, the control unit 600 returns to ACT31.

The paper discharge apparatus 40 of the embodiment includes the lower flapper 49 and the upper flapper 47. If the paper discharge unit 1 is incorporated into the POS terminal H, the paper discharge apparatus 40 can position the lower flapper 49 and the upper flapper 47 to select whether the receipt Y is to be looped toward the upper side (the printing surface side of the embodiment) or the lower side (the non-printing surface side of the embodiment). Therefore, the receipt Y can retreat without being affected by the peripheral devices.

The paper discharge unit 1 of the embodiment has an effect of the paper discharge apparatus 40. When the receipt Y is cut, the paper discharge unit 1 discharges the receipt Y retreated upward or downward to the outside from the POS terminal H. Since the customer cannot touch the receipt Y during printing, in the paper discharge unit 1, it is possible not only to maintain printing quality of the receipt Y, but also to prevent jamming of the receipt Y.

As described above, the paper discharge apparatus 40 of the embodiment includes the feed roller 43 that conveys the receipt Y printed by the printer 10 and discharges the receipt Y to the outside, the conveyance stop unit 601 that stops conveyance of the receipt Y by the feed roller 43 during printing of the receipt Y, the loop mechanism (the lower flapper 49 and the upper flapper 47) that selectively loops the receipt Y printed while conveyance of the receipt Y is stopped from the conveyance path 42 provided upstream of the feed roller 43 in the conveyance direction of the receipt Y to any one of the printing surface side or the non-printing side of the receipt Y, and the paper discharge unit 602 that rotates the stopped feed roller 43 and discharges the looped receipt Y when the printing of the receipt Y is complete.

According to the paper discharge apparatus 40 of the embodiment, the loop direction of the paper can be selectively determined.

The paper discharge unit 1 of the embodiment is the paper discharge unit 1 including the printer 10 that prints information on paper and the paper discharge apparatus 40 that discharges the receipt Y printed by the printer 10. The printer 10 includes the printing unit 201 that prints information on paper, the feeding unit 202 that feeds the printed receipt Y to the paper discharge apparatus 40, and the transmission unit 203 that transmits a cut signal indicating that printing is completed to the paper discharge apparatus 40. The paper discharge apparatus 40 includes the feed roller 43 that conveys the receipt Y printed by the printer 10 and discharges the receipt Y to the outside, the conveyance stop unit 601 that stops conveyance of the receipt Y by the feed roller 43 during printing of the receipt Y, the loop mechanism (the lower flapper 49 and the upper flapper 47) that selectively loops the receipt Y printed while conveyance of the receipt Y is stopped from the conveyance path 42 provided upstream of the feed roller 43 in the conveyance direction of the receipt Y to any one of the printing surface side or the non-printing side of the receipt Y, and the paper discharge unit 602 that drives the stopped feed roller 43 and discharges the looped receipt Y when the cut signal is received from the printer 10.

According to the paper discharge unit 1 of the embodiment, it is possible not only to select the loop direction of the paper, but also to prevent a customer from touching the receipt Y during printing. Accordingly, printing quality of the receipt Y can be maintained, and jamming of the receipt Y can be prevented.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

For example, in the embodiment, the cut signal is described as an example of the end signal. However, the embodiment is not limited thereto, and any signal indicating that printing by the printer 10 is completed may be used.

In the embodiment, the upper flapper 47 is not provided with an own driving unit and is rotated by the weight thereof. However, the embodiment is not limited thereto, and the upper flapper 47 may be driven by a driving source such as a flapper motor similarly to the lower flapper 49.

In the embodiment, the paper sensor 51 is provided upstream of the feed roller 43 in the conveyance direction of the receipt Y. However, the embodiment is not limited thereto, and the paper sensor 51 may be provided close to the downstream side of the feed roller 43 in the conveyance direction of the receipt Y. Then, when the paper sensor 51 detects the receipt Y, rotation of the feed roller 43 is immediately stopped to stop conveyance of the receipt Y.

WHAT IS CLAIMED IS:

1. A paper discharge apparatus, comprising:
a conveyance component configured to convey paper printed by a printer and discharge the printed paper to an outside;
a conveyance stop component configured to stop the conveyance of the paper by the conveyance component during printing of the paper;
a loop mechanism configured to selectively loop the paper printed while the conveyance is stopped from a conveyance path provided upstream of the conveyance component in a conveyance direction of the paper toward any one of a printing surface side of the paper and a non-printing surface side of the paper; and
a paper discharge component configured to drive the stopped conveyance component and discharge the looped paper when printing of the paper is completed.

2. The paper discharge apparatus according to claim 1, wherein the printing surface side is a side in which the paper is looped upward from the conveyance path and the non-printing surface side is a side in which the paper is looped downward from the conveyance path.

3. The paper discharge apparatus according to claim 2, wherein
the loop mechanism includes an upper flapper and a lower flapper arranged to face each other with the conveyance path interposed therebetween at home positions,
the loop mechanism includes
a lower flapper moving component configured to cause at least a part of the lower flapper to protrude upward from the home position, and
an upper flapper moving component configured to cause at least a part of the upper flapper to protrude downward from the home position, and
the lower flapper moving component causes at least a part of the lower flapper to protrude upward from the conveyance path such that the paper is looped upward and the upper flapper moving unit causes at least a part of the upper flapper to protrude downward from the conveyance path such that the paper is looped downward.

4. The paper discharge apparatus according to claim 3, wherein the lower flapper moving component rotates the lower flapper upward from the home position to cause at least a part of the lower flapper to protrude upward from the conveyance path and the upper flapper moving component rotates the lower flapper downward from the home position to cause the upper flapper to rotate downward by own weight of the upper flapper and at least a part of the upper flapper to protrude downward from the conveyance path.

5. The paper discharge apparatus according to claim 3, wherein the lower flapper is configured to rotate around a first support shaft.

6. The paper discharge apparatus according to claim 3, wherein the upper flapper configured to rotate around a second support shaft.

7. The paper discharge apparatus according to claim 1, wherein the printer comprises a processor and a memory.

8. A paper discharge system comprising a printer configured to print information on paper and a paper discharge apparatus configured to discharge the paper printed by the printer, wherein
the printer comprises
a printing component configured to print information on the paper,
a feeding component configured to feed the printed paper to the paper discharge apparatus, and
a transmission component configured to transmit an end signal indicating that printing is completed to the paper discharge apparatus, and
the paper discharge apparatus comprises
a conveyance component configured to convey the paper printed by the printer and discharge the paper to an outside
a conveyance stop component configured to stop the conveyance of the paper by the conveyance component during printing of the paper;
a loop mechanism configured to selectively loop the paper printed while conveyance is stopped from a conveyance path provided upstream of the conveyance component in a conveyance direction of the paper toward any one of a printing surface side of the paper and a non-printing surface side of the paper; and
a paper discharge component configured to drive the stopped conveyance component and discharge the looped paper upon reception of the end signal.

9. The paper discharge system according to claim 8, wherein the printing surface side is a side in which the paper is looped upward from the conveyance path and the non-printing surface side is a side in which the paper is looped downward from the conveyance path.

10. The paper discharge system according to claim 9, wherein
the loop mechanism includes an upper flapper and a lower flapper arranged to face each other with the conveyance path interposed therebetween at home positions,
the loop mechanism includes
a lower flapper moving component configured to cause at least a part of the lower flapper to protrude upward from the home position, and
an upper flapper moving component configured to cause at least a part of the upper flapper to protrude downward from the home position, and
the lower flapper moving component causes at least a part of the lower flapper to protrude upward from the conveyance path such that the paper is looped upward and the upper flapper moving component causes at least a part of the upper flapper to protrude downward from the conveyance path such that the paper is looped downward.

11. The paper discharge system according to claim 10, wherein the lower flapper moving component rotates the lower flapper upward from the home position to cause at least a part of the lower flapper to protrude upward from the conveyance path and the upper flapper moving component rotates the lower flapper downward from the home position to cause the upper flapper to be rotated downward by an own weight of the upper flapper and at least a part of the upper flapper to protrude downward from the conveyance path.

12. The paper discharge system according to claim 10, wherein the lower flapper is configured to rotate around a first support shaft.

13. The paper discharge system according to claim 10, wherein the upper flapper configured to rotate around a second support shaft.

14. The paper discharge system according to claim 8, wherein the printer comprises a processor and a memory.

15. The paper discharge system according to claim 8, wherein the paper discharge system is a point of sale terminal.

16. The paper discharge system according to claim 8, wherein the paper discharge system is an automatic teller machine.

17. The paper discharge system according to claim 8, wherein the paper discharge system is a kiosk terminal.

18. A paper discharge method, comprising:
conveying paper printed by a printer and discharging the printed paper to an outside;
a conveyance stop component configured to stopping the conveyance of the paper during printing of the paper;
selectively looping the paper printed using a loop mechanism while the conveyance is stopped from a conveyance path provided upstream of a conveyance component in a conveyance direction of the paper toward any one of a printing surface side of the paper and a non-printing surface side of the paper; and
driving the stopped conveyance component and discharging the looped paper when printing of the paper is completed.
